(19) United States
(12) Patent Application Publication
(10) Pub. No.: US 2013/0139325 A1
(43) Pub. Date: Jun. 6, 2013

(54) Combination Mallet and Ax Device

(71) Applicants: Todd Walker, Johnson City, TX (US); Kimberly Walker, Johnson City, TX (US)

(72) Inventors: Todd Walker, Johnson City, TX (US); Kimberly Walker, Johnson City, TX (US)

(21) Appl. No.: 13/311,810

(22) Filed: Dec. 6, 2011

(51) Int. Cl. B25F 1/00

(52) U.S. Cl. 7/145

(57) ABSTRACT

A combination mallet and ax device wherein the mallet has an opening adapted to selectively receive the ax.

### BACKGROUND

Hunters typically field-dress game animals near where the prey is felled. Failure to promptly empty the body cavity of digestive and excretory organs can cause the meat to have a strong, gamey taste or smell. However, hunters must take care not to cut or puncture any of those organs. Those organs contain contaminants such as urine, feces, or digestive fluids that can contaminate the meat.

Hunters often use hunting knives to field dress their game. While practical and convenient, hunting knives are generally ineffective for severing large bones. The obstacle presented by the pelvic bone often causes a hunter to unintentionally cut or puncture an organ, exposing the meat to contaminants.

Because splitting the pelvic bone reduces the risk of accidental contamination during field dressing, hunters employ various tools and methods to split the pelvic bone. Some use a rock to strike the back edge of a knife blade while holding the sharpened edge against the bone. To deliver a blow sufficient to sever a pelvic bone, the weight of the rock must be substantial. Further, it can be difficult to find an ideal rock in many locations.

There is therefore a need for a tool adapted to sever large bones in game animals and which is convenient to carry while hunting.

### BRIEF DESCRIPTION OF THE DRAWINGS

FIG. 1 is a side view of the device wherein the ax is in its stowed position inside the mallet;

FIG. 2 is a perspective view of the mallet component of the device;

FIG. 3 is a side view of the mallet component of the device;

FIG. 4 is a perspective view of the ax component of the device;

FIG. 5 is a side view of the ax component of the device;

FIG. 6 is an exploded view showing how the ax component fits inside the mallet component; and

FIG. 7 is a perspective view of a retaining member.

### DETAILED DESCRIPTION

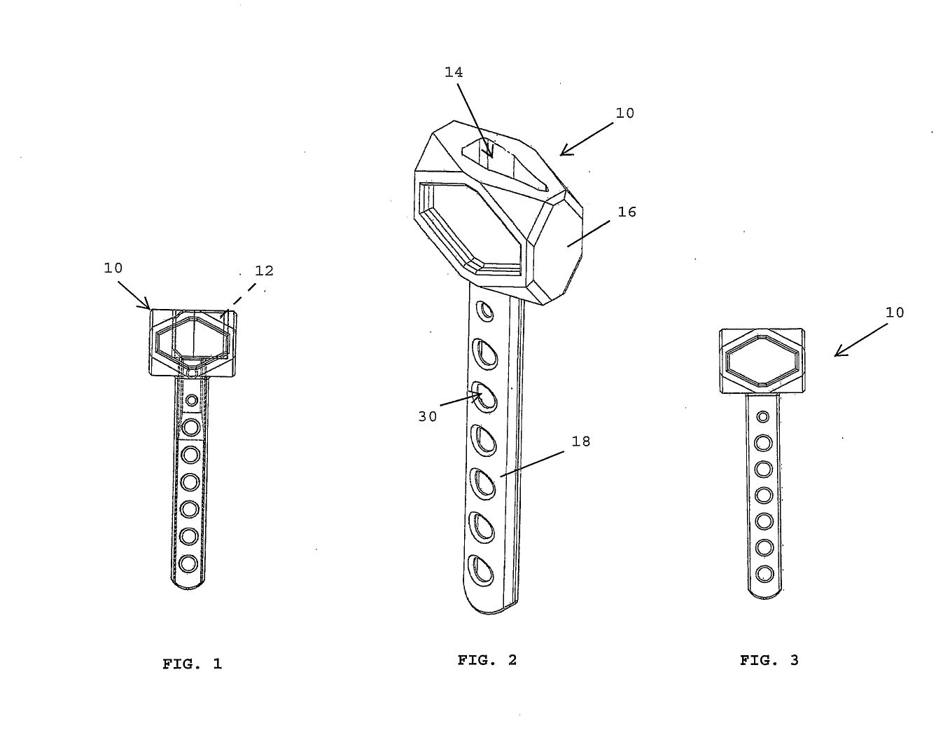

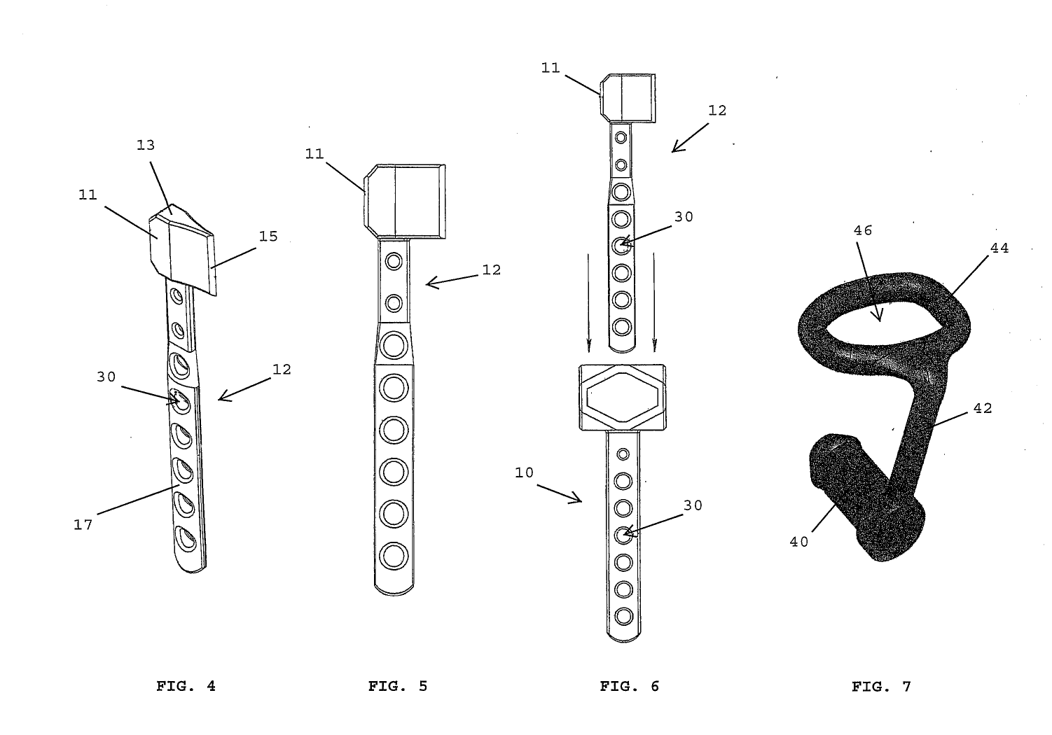

As shown in FIG. 1, the present invention comprises a combination mallet 10 and ax 12 device. FIGS. 2 and 3 show different views of the mallet 10 and FIGS. 4 and 5 show different views of the ax 12. The mallet 10 and ax 12 can be made of any suitable material, however, the preferred material is stainless steel, which makes for easier cleaning and increased longevity due to rust resistance. The mallet 10 and ax 12 can be any suitable shape and size. The mallet 10 is larger than the ax 12 and comprises a handle 18 and a head 16 with a generally flat surface adapted for striking other objects. The ax 12 is smaller than the mallet 10 and comprises a handle 17 and a head 13 having a first end 11 and a second end 15. The first end 11 is generally flatter and wider than the second end and is adapted to be struck by the mallet 10. The second end has a cutting edge 15 such as a blade. In some embodiments, the handles 17, 18 may comprise a plurality of openings 30. These openings 30 reduce the weight of the device and also provide a means for securing the two components 10, 12 together using a retaining member, as described below.

FIG. 1 shows the device in its transport or stowed position wherein the ax 12 is positioned inside the mallet 10. As shown in FIG. 2, the mallet 10 has an opening 14 in its head 16 adapted to receive the ax 12. The narrower ax handle 17 is inserted into the opening 14 and through the hollow mallet handle 18 until the majority of the ax handle 17 is positioned within the mallet handle 18 and the majority of the ax head 13 is positioned within the mallet head 16. In other embodiments (not shown), the mallet 10 may have an opening in the lower portion of its handle 18 for receiving the ax 12. In other embodiments (not shown), the ax 12 may be inserted into the mallet 10 in an inverted position wherein its head 13 is positioned in the lower portion of the mallet handle 18 with its handle 17 facing upward toward the mallet head 16.

In some embodiments, the ax 12 is secured inside the mallet 10 using the friction between the two components. In other embodiments, the ax 12 is secured inside the mallet 10 using a rubber member, screw, bolt, snap or other suitable retainer member 40. The retainer member 40 is inserted through aligned openings in both of the handles 17, 18 to prevent the two devices 10, 12 from inadvertently separating. The embodiment shown in FIG. 7 shows a retainer member 40 combined with a leash 42. The leash 42 is secured to the ax 12 or mallet 10 to help ensure that the retainer member 40 is always in close proximity. FIG. 7 shows an embodiment wherein the leash 42 is combined with a collar 44 having an opening 46 therein. The opening 46 is adapted to receive a portion of the mallet, such as the mallet handle 18. The collar 44 is sized to fit tightly around the portion of the mallet, such as the mallet handle 18.

FIG. 6 shows the device in its detached position wherein the ax 12 is removed from the mallet 12 and ready to use. The separation process is the reverse of the attachment process described above. To separate the two components 10, 12, the retainer member 40 is removed or disconnected to allow the ax 12 to be forced out of the opening 14 in the mallet head 16. After the components 10, 12 are separated, the device can be used by placing the cutting edge 15 of the ax 12 against the thing to be cut and striking the first end 11 of the ax 12 with the mallet head 16. The energy is transferred from the mallet 10 to the ax blade 15 to cut or break the thing to be cut.

Although described herein for field dressing large game, the device can be used for any suitable task, including, chopping logs, clearing brush, cleaning fish, and general demolition. The device is particularly useful in situations where it may be inappropriate or dangerous to use an ax which may require a full swing. The present invention allows for more precise cutting because it allows the ax blade 15 to be properly positioned then hit by the mallet 10 as opposed to aiming and swinging an ax.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. A cutting device comprising:
a mallet having a head, a handle, and an opening;
an ax having a head with a first end and a second end and a handle;
wherein the ax is adapted to be inserted into the opening in the mallet.

2. The cutting device of claim 1 wherein the mallet handle is hollow and adapted to receive the ax handle.

3. The cutting device of claim 1 further comprising a retaining member for securing the ax inside the mallet.

4. The cutting device of claim 1 wherein the first end of the ax head is wider than the second end of the ax head.

5. The cutting device of claim 1 wherein the opening is in the head of the mallet.

6. The cutting device of claim 1 wherein the opening is in the handle of the mallet.

7. The cutting device of claim 1 wherein the handle of the mallet comprises a plurality of openings for reduced weight.

8. The cutting device of claim 1 wherein the handle of the ax comprises a plurality of openings for reduced weight.

9. A cutting device comprising:
a mallet having a handle and a head with an opening therein;
an ax having a head with a first end and a second end and a handle;
wherein the device has a stowed position wherein the ax is inserted into the opening in the head of the mallet and a detached position wherein the ax is removed from the mallet.

10. The cutting device of claim 9 wherein the mallet handle is hollow and adapted to receive the ax handle.

11. The cutting device of claim 9 further comprising a retaining member for securing the ax inside the mallet.

12. The cutting device of claim 9 wherein the first end of the ax head is wider than the second end of the ax head.

13. A cutting device comprising:
a mallet having a handle with at least one opening therein and a head with an opening therein;
an ax having handle with at least one opening therein and a head with a first end that is wider than a second end;
a retaining member adapted to be selectively inserted through the opening in the mallet handle and the opening in the ax handle for securing the ax inside the mallet.
wherein the device has a stowed position in which the ax is inserted into the opening in the head of the mallet and a detached position wherein the ax is removed from the mallet.

14. The cutting device of claim 13 wherein the retaining member is combined to the mallet with a leash.

15. The cutting device of claim 14 wherein the leash is combined with a collar having an opening adapted to receive the mallet handle.

16. The cutting device of claim 13 wherein the head of the mallet has a first end and a second end, both ends being generally flat.

17. The cutting device of claim 13 wherein the second end of the ax head is sharp.
